(19) United States
(12) Patent Application Publication
(10) Pub. No.: US 2015/0007661 A1
(43) Pub. Date: Jan. 8, 2015

(54) ACOUSTIC ISOLATION CHAMBER

(71) Applicant: Sonex Metrology Ltd., Swords (IE)

(72) Inventors: Kenneth Horan, Dublin (IE); Michael Cunningham, Clane (IE); James Fryar, Dublin (IE); David Allen, Rathoe (IE)

(21) Appl. No.: 14/324,445

(22) Filed: Jul. 7, 2014

(30) Foreign Application Priority Data
Jul. 4, 2013 (GB) 1312046.4
Aug. 14, 2013 (GB) 1314576.8

(51) Int. Cl. H04R 1/02; G01N 29/24

(52) U.S. Cl. CPC H04R 1/02; G01N 29/2418
USPC 73/655; 181/264

(57) ABSTRACT

An acoustic isolation chamber. The chamber comprises a housing defining a volume. A first region of the volume is configured to receive a photoacoustic sensor head. A second region of the volume is configured to receive the UUT. A sound proofing means encompassing at least a portion of the volume.

### FIELD

The present invention relates to an acoustic isolation chamber. In particular the invention relates to an acoustic isolation chamber which provides a controlled environment during inspection of a unit under test.

### BACKGROUND

Failure analysis is the process of collecting and analysing data to determine the cause of a failure within materials, structures, devices and circuits fabricated thereon. Such analysis provides vital information when developing new products and improving existing products. Typically, this type of analysis relies on collecting failed components for subsequent examination of the cause of failure using various methods, such as microscopy and spectroscopy. Within the semiconductor industry, for example, particle contamination is of major concern. Particle contamination during the manufacturing process of devices may result in faulty devices. Thus it is desirable to minimise the risk of contaminating products with foreign bodies during the manufacturing process. Failure analysis techniques that utilise sound energy are known in the art. One such technique utilizes photoacoustics to perform structural characterisation. Noise from the ambient environment may distort the accuracy of photoacoustic measurements. This is undesirable.

There is therefore a need for an acoustic isolation chamber which addresses at least some of the drawbacks of the prior art.

### SUMMARY

These and other problems are addressed by provision of an acoustic isolation chamber which provides a controlled environment during photoacoustic inspection of a unit under test.

The present invention provides an acoustic isolation chamber comprising:
a housing defining a volume,
a first region of the volume is configured to receive one or more photoacoustic measurement cells,
a second region of the volume is configured to receive a unit under test (UUT), and a sound proofing means encompassing at least a portion of the volume.

By providing a sound proofing means, ambient noise is isolated from entering the second region, and thus ensures that the photoacoustic measurements are as accurate as possible.

The sound proofing means may comprise a cavity.

The cavity may be evacuated.

The evacuated cavity may extend around perimeter of the volume.

The volume may be compartmentalised.

The compartments of the volume may be arranged in a tiered configuration.

The first region may be located in a first compartment.

The second region may be located in a second compartment.

The acoustic isolation chamber may further comprise a third compartment for accommodating utilities therein.

The acoustic isolation chamber may further comprise an isolating member located intermediate the second compartment and the third compartment for providing both acoustic and particle isolation of the third compartment from the second compartment.

The acoustic isolation chamber may further comprise a fourth compartment for accommodating additional utilities therein.

The fourth compartment may be acoustically isolated from one or more of the first, second or third compartments.

The utilities may comprise a drive means.

Preferably, the UUT is mounted on a moveable carrier member. The moveable carrier member may be operably coupled to the drive means.

A spindle may extend between the drive means and the moveable carrier member.

The acoustic isolation chamber may further comprise one or more vents for accommodating air flow through the volume.

The acoustic isolation chamber may further comprise:

a first input vent in communication with the third compartment for inputting a stream of air to the third compartment.

The acoustic isolation chamber may further comprise

a first output vent in communication with the third compartment through which air exits from the third compartment.

The acoustic isolation chamber may further comprise

an input vent in communication with the second compartment for inputting a stream of air to the second volume.

The acoustic isolation chamber may further comprise:

an output vent in fluid communication with the second and third compartment through which air exits from the second compartment and enters the third compartment.

The output vent may be located intermediate the second and third compartments.

The sound proofing means may include at least one of a liquid, gas, gel, vacuum, or particulate material.

The UUT may comprises a solid state UUT or a semiconductor wafer.

The cavity may comprise a first volume associated with the first region.

The cavity may comprise a second volume associated with the second region.

The first and second volumes may be in a tiered configuration.

The one or more photoacoustic measurement cells may be provided on a photoacoustic sensor head, the photoacoustic sensor head may further comprise:

at least one light source for optically exciting the unit under test (UUT), and
at least one trap volume for capturing acoustic energy emanating from the UUT as result of optical excitation thereof.

The photoacoustic sensor head may comprise a circuit board having one or more acoustic pick-ups operably coupled thereto.

The photoacoustic sensor head may further comprise a sensor housing for accommodating the circuit board therein.

The at least one light source may be mounted on a first surface of the sensor housing.

The at least one trap volume may be provided on a second surface of the sensor housing, wherein the first and second surfaces are provided at respective opposite sides of the sensor housing.

The circuit board may be located intermediate the at least one light source and the at least one trap volume.

The circuit board may be perforated for accommodating light from the at least one light source therethrough such that light from the at least one light source passes through the circuit board for illuminating the at least one trap volume.

The sensor housing may be in a modular configuration with first and second members configured for operably coupling together.

The photoacoustic sensor head may comprise a plurality of light sources and a plurality of trap volumes.

The light sources may be accommodated in respective spigots which are configured for operably engaging respective sockets formed on a surface of photoacoustic sensor head.

The light sources may comprise fibre optic elements.

The acoustic isolation chamber may further comprise a delivery mechanism for facilitating loading the UUT to the volume.

The delivery mechanism may comprise a slideable tray.

The acoustic isolation chamber may further comprise a safety interlock mechanism configured for switching a laser when tripped.

The carrier member may utilise a vacuum for securing the UUT thereon.

The present invention also provides an inspection assembly comprising an acoustic isolation chamber; and a sensor head operable to perform photoacoustic analysis within the acoustic isolation chamber.

The present invention also provides an acoustic isolation chamber comprising:

a volume for accommodating a unit under test (UUT);
a means for receiving a photoacoustic sensor head for facilitating photoacoustic analysis of the UUT;
an input vent for receiving a stream of air into the chamber; and
an output vent through which a stream of air exits the chamber.

By providing an input and an output vent to enable a flow of air to pass through the isolation chamber, it reduces the risk of a UUT being contaminated from particulates.

The present invention also provides an acoustic isolation chamber comprising:

a housing defining a volume,
a first region of the volume is configured to receive one or more photoacoustic measurement cells,
a second region of the volume is configured to receive a unit under test (UUT);
wherein the first region is located in a first compartment and the second region is located in a second compartment.

By compartmentalising the isolation chamber, it reduces the risk of particles from the first region contaminating the UUT.

The present invention also provides acoustic isolation chamber comprising:

a housing defining a volume,
a first region of the volume is configured to receive one or more photoacoustic measurement cells,
a second region of the volume is configured to receive a unit under test (UUT), and
a delivery mechanism for facilitating loading the UUT to the volume.

The delivery mechanism facilitates the safe delivery of the UUT to the isolation chamber.

The present invention also provides an acoustic isolation chamber comprising:

a housing defining a volume,
a first region of the volume is configured to receive one or more photoacoustic measurement cells,
a second region of the volume is configured to receive a unit under test (UUT); and
a moveable carrier member configured for mounting the UUT.

The moveable carrier member ensures that the UUT may be securely mounted to the second region for an accurate photoacoustic measurement.

These and other features will be better understood with reference to the following Figures which are provided to assist in an understanding of the present teaching.

### BRIEF DESCRIPTION OF THE DRAWINGS

The present teaching will now be described with reference to the accompanying drawings in which:

FIG. 1 is a perspective view of an acoustic isolation chamber in accordance with the present teaching.

FIG. 2 is a cross sectional view of a detail of the acoustic isolation chamber of FIG. 1.

FIG. 3 is a cross sectional view of a detail of the acoustic isolation chamber of FIG. 1.

FIG. 4 is a cross sectional view of a detail of the acoustic isolation chamber of FIG. 1.

FIG. 5 is a perspective view a sensor head which is also in accordance with the present teaching.

FIG. 6 is another perspective view of the sensor head of FIG. 5.

FIG. 7 is an exploded view of the sensor head of FIG. 5.

FIG. 8 is another exploded view of the sensor head of FIG. 5.

FIG. 9 is a further exploded view of the sensor head of FIG. 5.

FIG. 10 is an exploded side cross sectional view of the sensor head of FIG. 9.

FIG. 11 is a cross sectional side view of the sensor head of FIG. 5.

FIG. 12 is a cross sectional side view of an acoustic isolation chamber in accordance with the present teaching.

FIG. 13 is a cross sectional side view of an acoustic isolation chamber in accordance with the present teaching.

FIG. 14 is a cross sectional side view of an acoustic isolation chamber in accordance with the present teaching.

FIG. 15 is a cross sectional side view of an acoustic isolation chamber in accordance with the present teaching.

FIG. 16 is a cross sectional side view of a detail of the acoustic isolation chamber in accordance with the present teaching.

FIG. 17 is a cross sectional side view of a detail of the acoustic isolation chamber in accordance with the present teaching.

FIG. 18 is a perspective view of another acoustic isolation chamber in accordance with the present teaching; and

FIG. 19 is a side view of another acoustic isolation chamber in accordance with the present teaching.

### DETAILED DESCRIPTION OF THE DRAWINGS

The application will now be described with reference to some exemplary acoustic isolation chambers which are provided to assist in an understanding of the present teaching. It will be appreciated that for simplicity and clarity of illustration, where considered appropriate, reference numerals may be repeated among the figures to indicate corresponding or analogous elements.

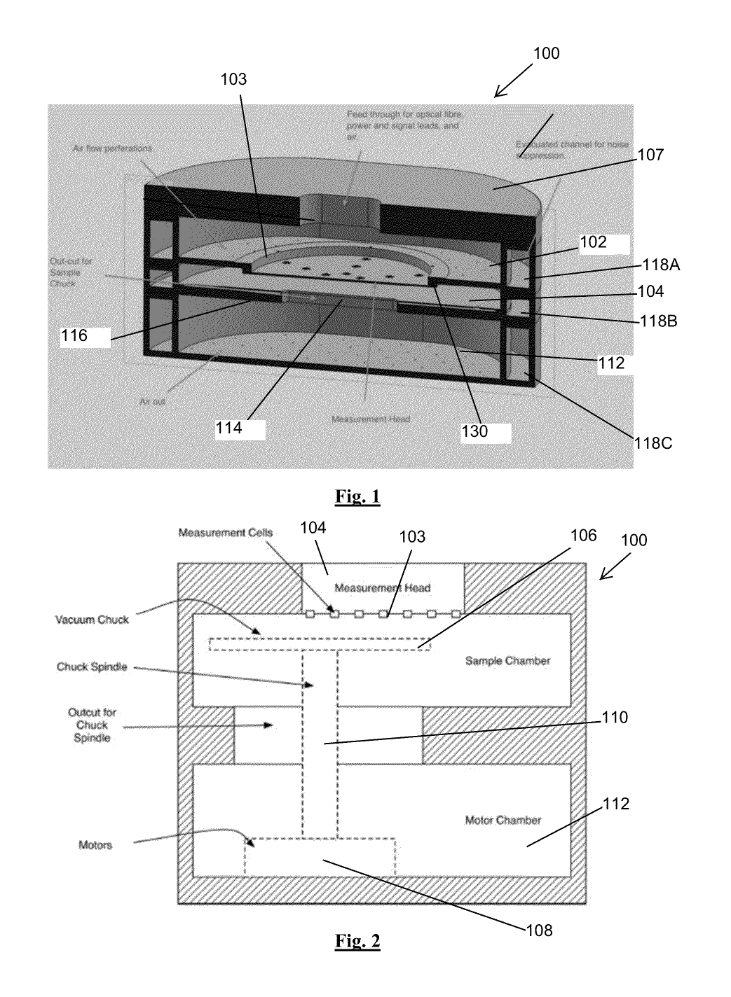

Referring to the drawings and initially to FIGS. 1 and 2 there is provided an acoustic isolation chamber 100 which provides a controlled environment during photoacoustic inspection of a unit under test. The chamber 100 comprises a first region defining a sensor volume 102 for accommodating a photoacoustic sensor head 200 therein. The sensor head 200 utilises sound energy resultant from light excitation of a unit under test (UUT) to perform structural characterisation thereof. The sensor head may include one or more photoacoustic measurements cells. A laser may be used to provide the excitation light. The UUT is located in a second region which defines a measurement volume 104. A rotatable carrier member 106 is operable within the measurement volume 104 for rotating the unit under test. In the exemplary arrangement, the carrier member 106 is provided by a chuck that is operably coupled to a drive means via a spindle 110. The drive means is provided by a motor 108. A third region defines a utility volume 112 for accommodating the motor 108 therein. Each of the volumes 102, 104 and 112 provide respective compartments in a housing 107 of the chamber 100. A cut out portion 114 is provided in a member 116 that divides the measurement volume 104 and the utility volume 112 for accommodating the rotatable spindle 110 such that the spindle 110 extends between the measurement volume 102 and the utility volume 112. The utility volume 112 isolates the motor 108 from the measurement volume 104 in order to reduce the risk that particles emanating from the motor 108 will contaminate the UUT. The major source of particles within the chamber 100 that could contaminate the UUT originates from the motor 108. The friction between the moving parts of the motor 108 creates particles that could be harmful to sensitive UUTs such as semiconductor wafers. Any particles that fall on sensitive UUTs during photoacoustic inspection may result in faulty devices as would be understood by those skilled in the art.

A sound proofing means, namely, a sound suppressing cavity 118 is provided inside the perimeter of the housing 107. The cavity 118 may be evacuated or filled with a sound suppressing means such as a liquid, gas, gel, or a particulate material. The sound suppressing cavity 118 isolates ambient noise from entering the measurement volume 104. In the exemplary arrangement three sounding suppressing cavities are provided 118A, 118B and 118C which form channels inside the perimeter of the housing 107. Each of the volumes 102, 104 and 112 are associated with corresponding sound suppressing cavities 118A, 118B and 118C. In the exemplary arrangement the volumes 102, 104 and 112 are provided in a tiered configuration. Similarly, the cavities 118A-118B are provided in tiered configuration. The photoacoustic metrology tool of the present teaching may include a safety interlock mechanism configured for switching off the laser used to optically excite the UUT. This is an important safety feature as it ensures that operators are not accidentally exposed to the laser beam which could be harmful. For example, if the acoustic isolation chamber 100 is opened while the laser is active the safety interlock mechanism will automatically deactivate the laser.

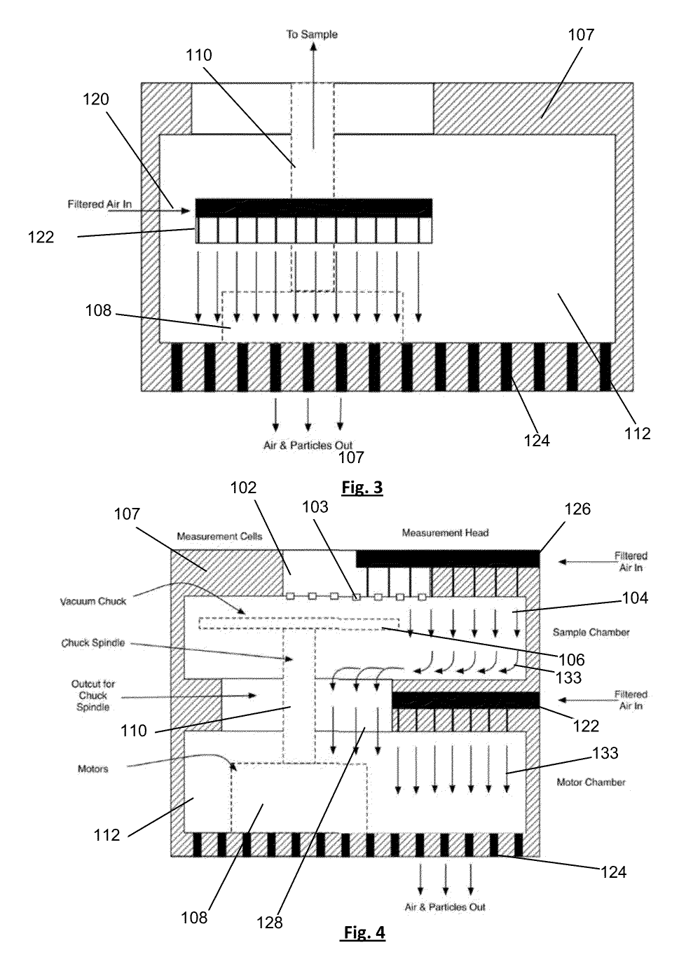

Referring now to FIGS. 3 and 4 an airflow system 120 is incorporated into the chamber 100 in order to reduce the risk of the UUT being contaminated from particulates. The air flow system 120 is configured for blowing particulates out of the chamber 100. The air flow system 120 includes a first input vent 122 for inputting a stream of filtered air into the utility volume 112. The air flow system 120 provides a laminar air flow in the region of the UUT and the surrounding regions. The stream of air exits the utility volume 112 via a first output vent 124. As the stream exits the utility volume 112 via the output vent 124 particulates originating from friction between the moving parts of the motor 108 are carried out of the utility volume 112 in the stream of air. Thus reducing the risk that the particles emanating from the utility volume 112 will enter the measurement volume 104. Therefore the risk that the UUT will be contaminated with foreign bodies is significantly reduced. Optionally, the airflow system 120 may also be configured for providing a stream of air into the measuring volume 104. The air flow system 120 may include a second input vent 126 for inputting a secondary stream of filtered air into the measurement volume 104. The secondary stream of air exits the measurement volume 104 via a second output vent 128. The second output vent 128 is in fluid communication with the utility volume 112. As the stream of air exits the measurement volume 104 via the second output vent 128 particles are carried out of the measurement volume 104 and into the utility volume 112 and they will ultimately exit the chamber 100 via the first output vent 124. The direction of the laminar air flow streams are indicated by the arrows 133 in FIG. 4.

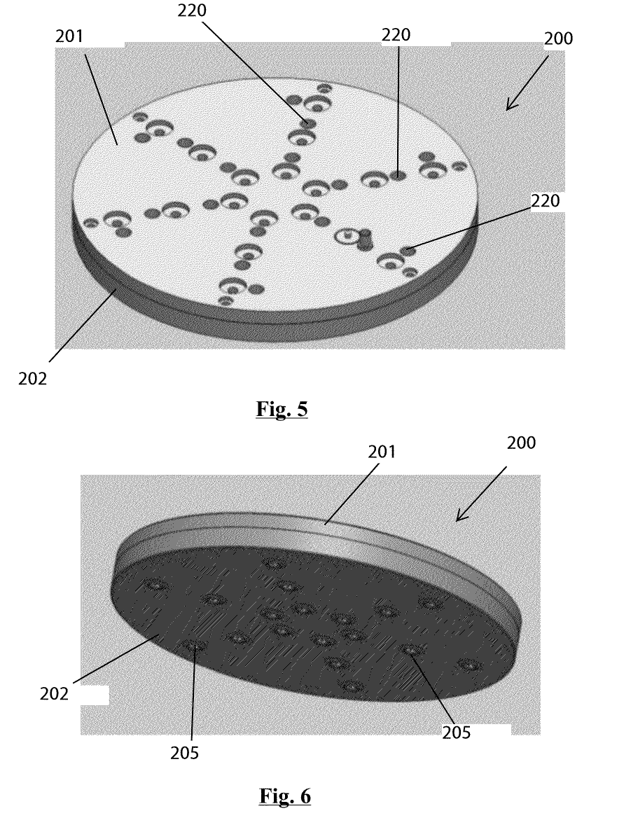

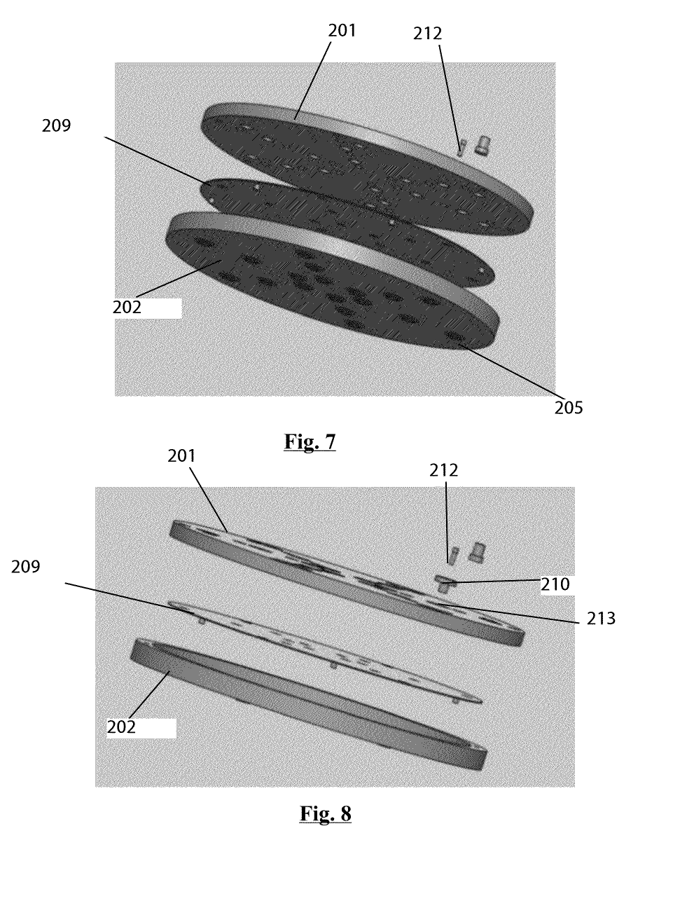

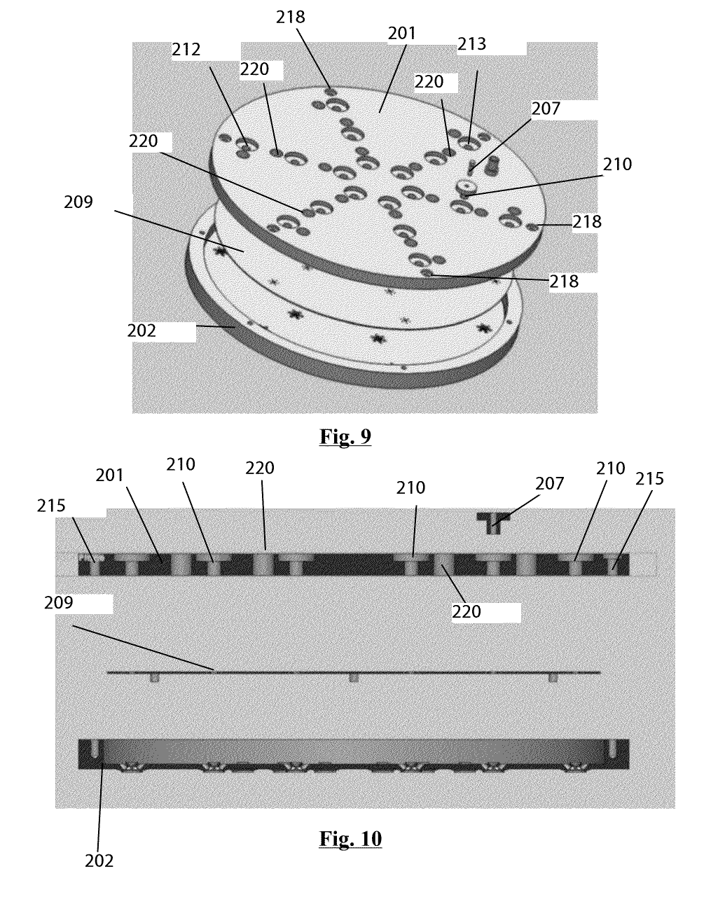

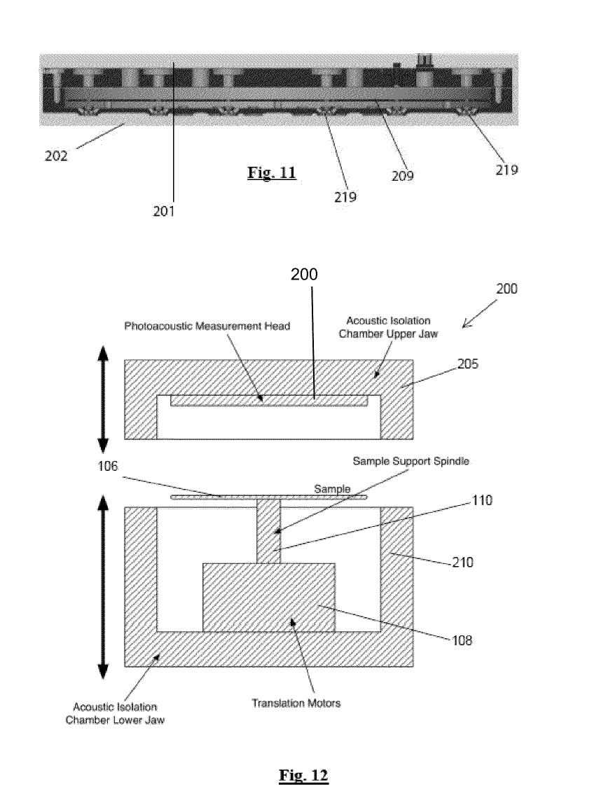

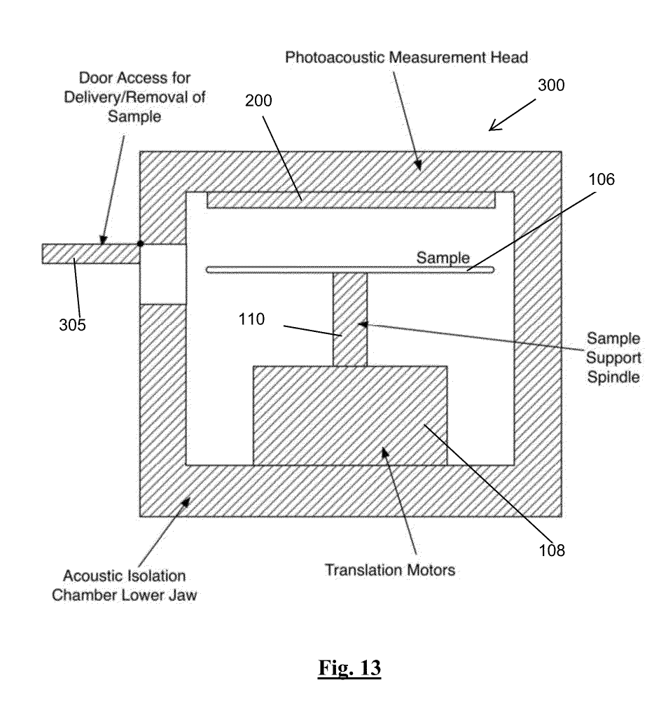

Referring now to FIGS. 5 to 11, there is provided a photoacoustic sensor head 200 which is configured for being located in the measurement volume 104. The floor of the measurement volume 104 comprises an aperture 130 which provides a slot for receiving the sensor head 200. In the exemplary arrangement the aperture 130 is circular. However, it will be appreciated by those skilled in the art that the aperture may be any desired shape. In the exemplary arrangement the sensor head 200 is provided in a modular configuration with a top member 201 and a bottom member 202 configured for releasably coupling together. The top member 201 is configured to receive the inputs and outputs components of the sensor head such as a fibre optic which provides a light source 212 for optically exciting the UUT as it is being rotated on the chuck. The bottom member 202 has a plurality of acoustic trap volumes 205 formed therein for capturing acoustic energy emanating from the UUT. The UUT is in acoustic communication with the trap volumes 205 such that acoustic energy emanating from the UUT as result of optical excitation thereof enters the trap volumes 205.

The top member 201 and the bottom member 202 together form a housing for accommodating a circuit board 209 therein. In the exemplary arrangement, the fibre optic is accommodated in a spigot 210 which is seated in a complementary shaped socket 213 on the top member 201. The top member 201 and the bottom member 202 include complementary formations which inter-engage for securing the top and bottom members together. In the exemplary arrangement, plugs 215 extend through apertures 218 formed on the top and bottom members for securing the respective members together. Fastening elements 219 on the bottom member 202 are configured to operably engage corresponding plugs 215.

FIGS. 7-10 show exploded views of the modular arrangement of the device 200. The bottom member 202 houses the measurement cells (trap volumes 205) and sealing windows. Sandwiched between the bottom member 202 and the upper member 201 is the circuit board 209 onto which the microphone wires of acoustic pickups are operably coupled. The circuit board 209 may include a control circuit (not shown) which is co-operable with the acoustic pick-ups. Connector outputs of the circuit board 209 are fed out holes 220 formed on the upper member 202. The connector outputs may be Bayonet Neill-Concelman (BNC), SMA or the like. The upper member 201 of the assembly also houses the excitation optics. In this configuration, the excitation light from the light source 212 passes through apertures formed on the circuit board 209. Thus the circuit board 205 is perforated for accommodating light therethrough such that light passes from the light source 212 through the circuit board 209 for illuminating the trap volumes 205.

In operation, the UUT is loaded to the measurement volume 104 and placed on the chuck. The photoacoustic sensor head 200 is located in the sensor volume 102 and is seated in the aperture 130 such that it is in optical communication with the measurement volume 104. The motor 108 drives the chuck via the spindle 110 such that the UUT is rotated relative to the light source 212 housed in the upper member 201 of the sensor head 200. Light from the light source 212 enters the acoustic trap volumes 205 through a transparent window and is intensity-modulated at a predetermined frequency. Some light is absorbed by the UUT on or close to the incident surface causing periodic surface heating to occur at the modulation frequency. The periodic surface heating in the UUT provides a source of thermal waves that propagate from the UUT. This periodic heating causes a periodic pressure variation which is picked up by acoustic pick-ups on the sensor head 200. The acoustic pick-ups are transducers configured for converting mechanical vibrations resulting from acoustic energy into electrical energy. As the modulation frequency is related to the thermal diffusion length of the material of the UUT, various depths within the UUT can be probed. A test measurement may be obtained by varying the position on the UUT and/or the frequency at which the light is chopped. Alternatively, a test measurement may be obtained by determining the acoustic signal of the UUT as a function of the wavelength of the incident light source 212. A graphical representation of the photoacoustic amplitude and/or phase may be generated for displaying on a visual display unit operably coupled to the circuit board 209. In order to reduce the risk that the UUT is contaminated from particles, the air flow system 120 is activated for blowing contaminates out of the chamber 100. The air flow system 120 may be controlled such that it is selectively activated when desired. For example, when the sensor head 200 is performing a photoacoustic measurement on the UUT, the air flow streams may be temporarily suspended to reduce the risk that noise from the air flow streams could affect the accuracy of the measurement.

In order to operate within a production environment and at production speeds the photoacoustic head 200 may be placed within the acoustic isolation chamber. The acoustic isolation chamber also encloses the unit under test. A mechanism may be provided to deliver and remove the UUT prior to and post measurement respectively. Referring now to FIG. 12 an exemplary delivery mechanism is illustrated. In this arrangement, the acoustic isolation chamber 200 is divided into an upper member 205 and a bottom member 210. Depending on the requirements of the local conditions, either the upper member 205 or the lower member 210 (or possibly both) will move with respect to its counterpart forming an opening between the two members. This opening facilitates the safe delivery of the UUT prior to the chamber 200 being resealed. Advantages of this mechanism include simplicity of design and cost of production however the wide extent of the opening may result in the introduction of particles if the surrounding environment is not properly managed. Additionally, this mechanism allows for the operation of multiple delivery mechanisms concurrently, e.g. a robotic arm on entering from the right hand side could remove a UUT which has just been tested, while a second robotic entering from the left hand side could, concurrently deliver the next UUT in the series.

Referring now to FIG. 13, another delivery mechanism is illustrated which provides access to the acoustic isolation chamber 300 via a side door 305 on the chamber aligned with the wafer chuck 106. Under operation, the side door 305 opens to allow access to the interior of the chamber 300 for the delivery mechanism e.g. a robotic arm. This method of access allows a reduction in the exposure of the chamber interior to the surrounding environment. The opening must also be large enough to accommodate the wafer plus loading mechanism in use.

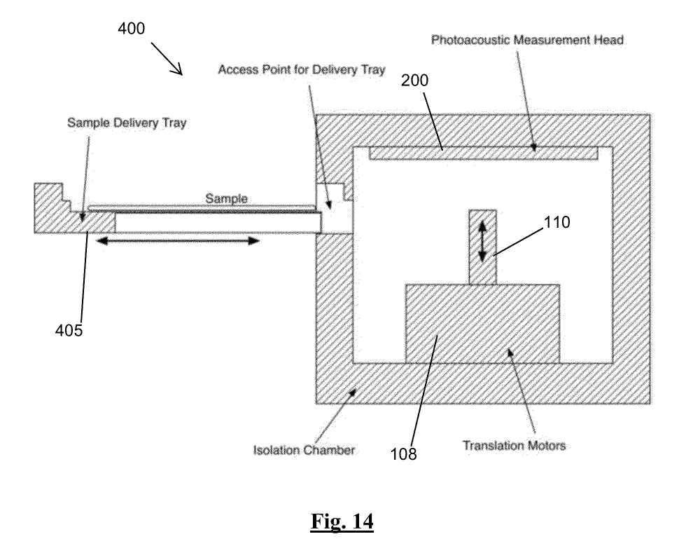

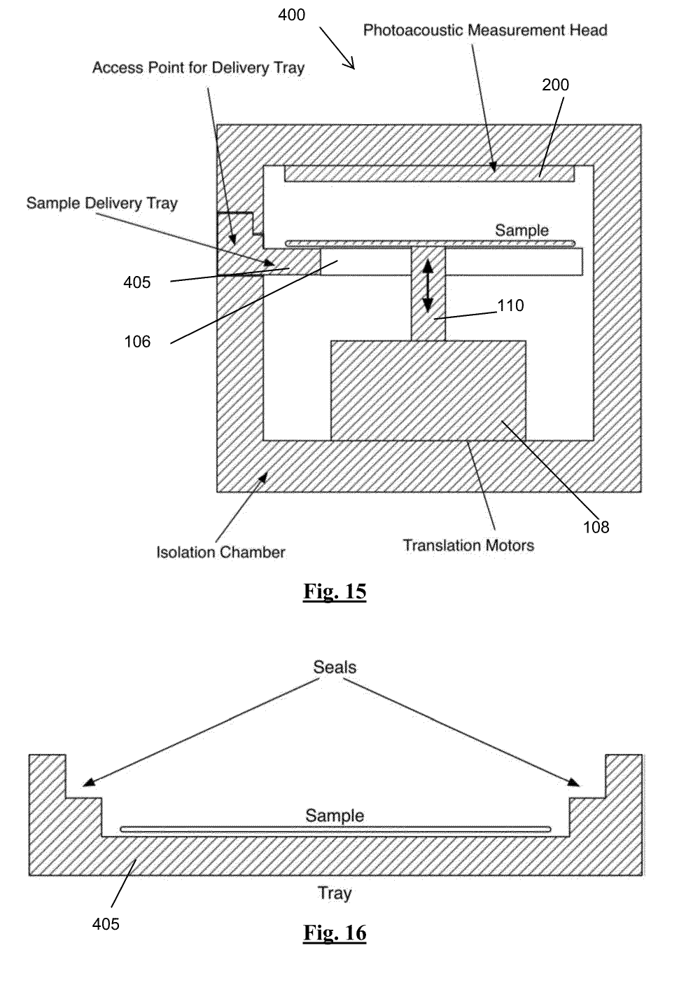

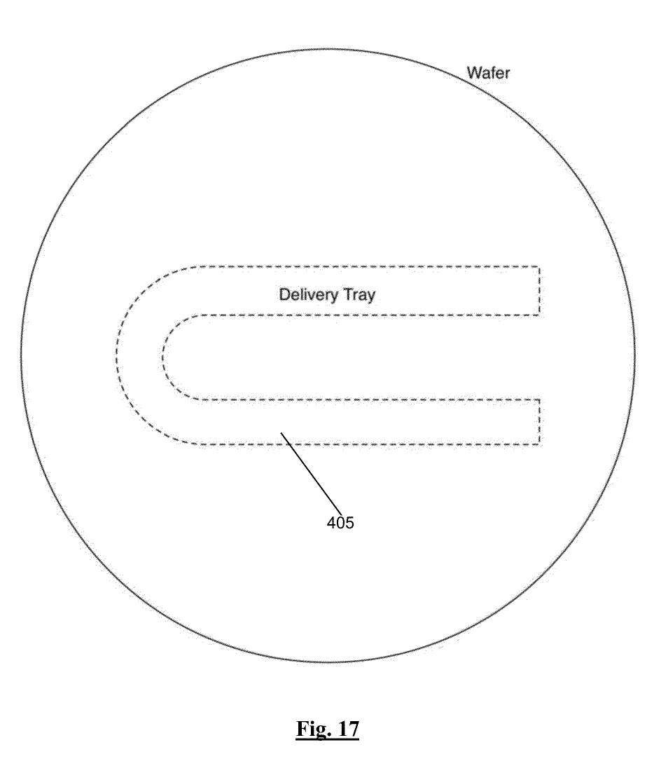

Referring now to FIGS. 14 and 15, a further delivery mechanism is illustrated. The sample is placed on a tray 405 outside the acoustic isolation chamber 400. The tray 405 is slideable for transferring the sample to the interior of the chamber and in doing so reseals the volume. The chuck can then “pop-up” to receive the UUT. Additionally, a vacuum may be provided on the delivery tray 405 or chuck to facilitate/preserve sample alignment. The vacuum on the chuck ensures that that the UUT is secured thereon. The tray 405 may be fork shaped as illustrated in FIG. 17 to allow clearance for the movement of the chuck spindle 110 during measurement. The tray may be symmetrical to seal the chamber when the tray is in the open position receiving the wafer. This mechanism minimises the opening extent and the open period.

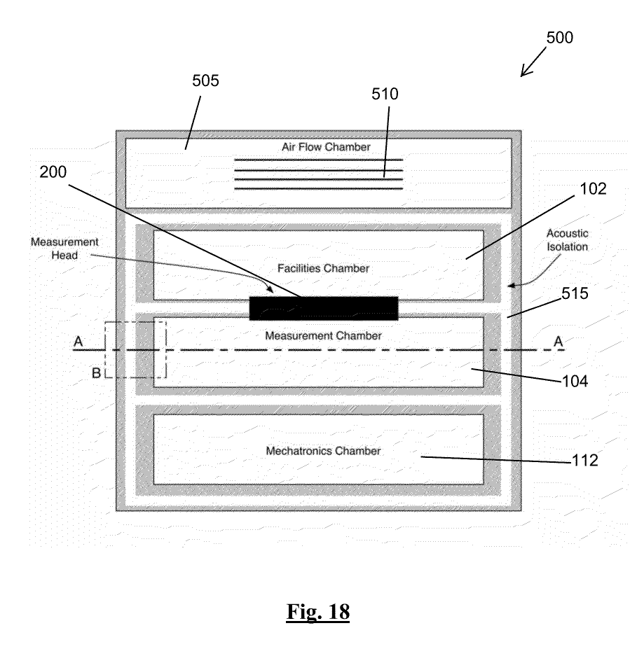

Referring now to FIG. 18 there is provided another photoacoustic isolation chamber 500 which is also in accordance with the present teaching. For convenience like components to those previously described are indicated by similar reference numerals. In addition to a sensor volume 102, measurement volume 104 and utility volume 112, there is also provided a second utility volume 505. The second utility volume 505 may be used to accommodate additional utilities as desired such as components of an air system or cooling system or the like. In the exemplary arrangement, the second utility volume 505 includes one or more air vents 510 for facilitating air circulation within the volume. An acoustic isolation means 515 may be provided for acoustically isolating the second utility volume 505 from one or more of the other volumes 102, 104 and 112. In the exemplary arrangement, the acoustic isolation means includes an evacuated cavity. Alternatively, the acoustic isolation means may contain at least one of a liquid, gas, gel, or particulate material in order to isolate noise emanating from the second utility volume entering the other volumes.

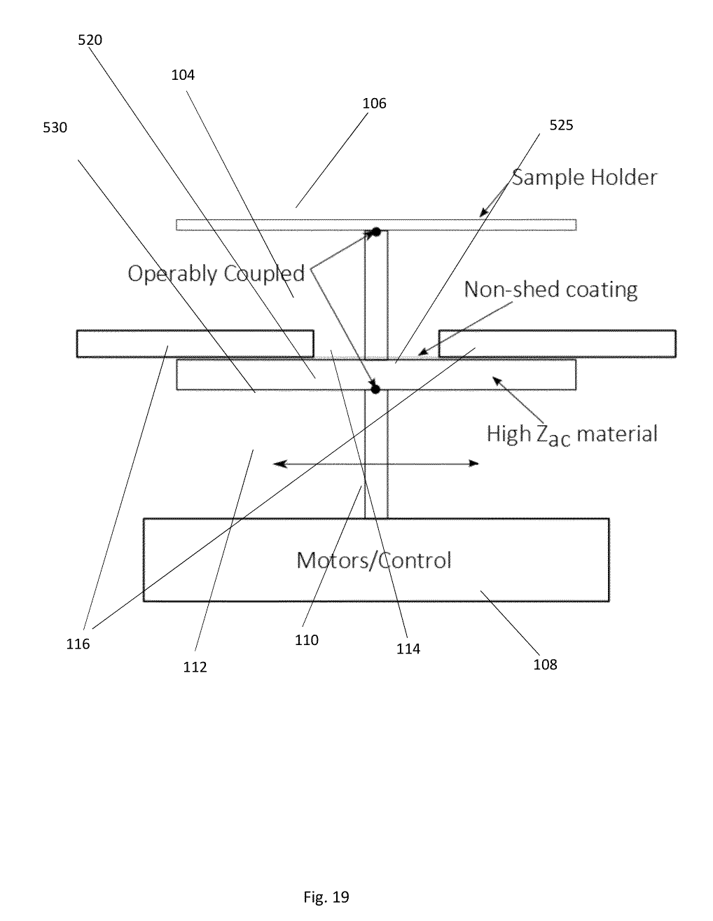

Referring now to FIG. 19, there is provided another photoacoustic isolation chamber 500 which is also in accordance with the present teaching. For convenience like components to those previously described are indicated by similar reference numerals. This photoacoustic isolation chamber includes an isolating member 520 attached to the spindle 110 and located intermediate the measurement volume 104 and the utility volume 112 for providing both acoustic and particle isolation of the utility volume 112 from the measurement volume 104. This further reduces the risk of UUT contamination from both particles and acoustic noise emanating from the motor 108 in the utility volume 112 and entering the measurement volume 104.

The isolation member 520 is affixed around a portion of the length of the spindle 116 such that it moves with the spindle 116 so as to provide a permanent seal around the cut-off portion 114. In the embodiment of FIG. 19, this is achieved by arranging the isolating member 116 such that its top surface 525 makes contact with the surface of the member 116 located adjacent the cut-out portion 114 in the utility volume 112, However, it will be appreciated that in an alternative embodiment, the bottom surface 530 of the isolating member 520 could be arranged to make contact with the surface of the member 116 located adjacent the cut-out portion 114 in the measurement volume 104. It should however be appreciated that furthermore in some circumstances the isolating member 116 may not be able to make direct contact with member 116, due to the possibility of introducing particles at the rubbing surfaces.

The isolation member 520 may be affixed around a portion of the length of the spindle 116 by any suitable means. For example, it can be directly affixed to the spindle 116 by a mechanical weld. Alternatively, it may be affixed to the spindle by a spring loaded mechanism, in order to minimise any stresses caused from making contact with member 116 as the spindle 110 moves about its axis.

In order that the isolating member 520 can provide the required amount of isolation, it is adapted to have lateral dimensions which are at least equal to the cut out portion 114 plus the travel range of the motor. This is to ensure that the isolating member 520 extends over the cut-out portion 114 at every position of the spindle in its 2D plane of movement in order to provide the necessary seal.

The isolating member 520 is fabricated from a high acoustic impedance material. An example of such a material is 316 series stainless steel. The material should have a thickness so as to provide an adequate level of acoustic isolation, for example between 5 and 15 mm. In addition, the isolation member 520 is provided with a non-particle shedding coating if necessary. An example of this material type is PTFE. The will conform with the structure being coated.

The acoustic isolation chambers as described in the present application provide a flexible, low cost, non-destructive and highly sensitive metrology tool with ultra-fast imaging speed for in-line characterization of surface and sub-surface defects within advanced semiconductor devices. Such defects are typically located anywhere from a few to several hundred microns beneath the surface and are often covered by optically opaque multi-layer structures. It is difficult to detect such defects non-invasively using conventional inline metrology tools based on optical methods. The acoustic isolation chambers of the present disclosure facilitate non-contact investigation of large area semiconductor wafers and similar samples. Wafers may be tested non-destructively in real time without the need for additional gases.

It will be understood that what has been described herein are exemplary acoustic isolation chambers. While the present application has been described with reference to exemplary arrangements it will be understood that it is not intended to limit the teaching of the present application to such arrangements as modifications can be made without departing from the spirit and scope of the application. While the exemplary acoustic isolation chamber has been described as comprising one or more sound suppressing cavities 118A-118C, it will be appreciated that the sound suppressing cavities are optional. Furthermore, the airflow system 120 has been described as being operable to generate one or more laminar air flows, it will be appreciated by those skilled in the art that the airflow system is optional. While in the exemplary embodiments the unit under test has been described as semiconductor wafers and the like, it is not intended to limit the UUT to such articles. It is envisaged that the UUTs could include for example, electronic products such as printed circuit boards (PCBs), LCDs, transistors, automotive parts, aeroplane parts, lids and labels on product packages, agricultural vegetation (seed corn, fruits, vegetables, or the like), and medical devices such as stents or the like.

Similarly the words comprises/comprising when used in the specification are used to specify the presence of stated features, integers, steps or components but do not preclude the presence or addition of one or more additional features, integers, steps, components or groups thereof.

1. An acoustic isolation chamber comprising:
a housing defining a volume,
a first region of the volume is configured to receive one or more photoacoustic measurement cells,
a second region of the volume is configured to receive a unit under test (UUT), and
a sound proofing means encompassing at least a portion of the volume.

2. An acoustic isolation chamber as claimed in claim 1, wherein the sound proofing means comprises a cavity.

3. An acoustic isolation chamber as claimed in claim 1, wherein the sound proofing means comprises a cavity and the cavity is evacuated.

4. An acoustic isolation chamber as claimed in claim 1, further comprising a safety interlock mechanism configured for switching a laser when tripped.

5. An acoustic isolation chamber as claimed in claim 1,
wherein the first region is located in a first compartment and the second region is located in a second compartment; and
wherein the acoustic isolation chamber further comprises a third compartment for accommodating utilities therein.

6. An acoustic isolation chamber as claimed in claim 5, further comprising an isolating member located intermediate the second compartment and the third compartment for providing both acoustic and particle isolation of the third compartment from the second compartment.

7. An acoustic isolation chamber as claimed in claim 1, wherein the UUT is mounted on a moveable carrier member operably coupled to a drive means.

8. An acoustic isolation chamber as claimed in claim 1, wherein the UUT is mounted on a moveable carrier member operably coupled to a drive means. the carrier member utilises a vacuum for securing the UUT thereon.

9. An acoustic isolation chamber as claimed in claim 1, further comprising one or more vents for accommodating air flow through the volume.

10. An acoustic isolation chamber as claimed in claim 5, further comprising:
a first input vent in communication with the third compartment for inputting a stream of air to the third compartment and
a first output vent in communication with the third compartment through which air exits from the third compartment.

11. An acoustic isolation chamber as claimed in claim 5, further comprising
an input vent in communication with the second compartment for inputting a stream of air to the second volume and
an output vent in fluid communication with the second and third compartment through which air exits from the second compartment and enters the third compartment.

12. An acoustic isolation chamber as claimed in claim 1, wherein the sound proofing means includes at least one of a liquid, gas, gel, vacuum or particulate material.

13. An acoustic isolation chamber as claimed in claim 1, wherein the UUT comprises a solid state UUT or a semiconductor wafer.

14. An acoustic isolation chamber as claimed in claim 1, wherein the one or more photoacoustic measurement cells are provided on a photoacoustic sensor head, the photoacoustic sensor head further comprises:
at least one light source for optically exciting the unit under test (UUT), and
at least one acoustic pick-up for capturing acoustic energy emanating from the UUT as result of optical excitation thereof; wherein the photoacoustic sensor head comprises a circuit board having one or more acoustic pick ups operably coupled thereto.

15. An acoustic isolation chamber as claimed in claim 1, further comprising a delivery mechanism for facilitating loading the UUT to the volume.

16. An acoustic isolation chamber as claimed in claim 1, further comprising a delivery mechanism for facilitating loading the UUT to the volume wherein the delivery mechanism comprises a slideable tray.

17. An acoustic isolation chamber comprising:
a volume for accommodating a unit under test (UUT);
a means for receiving a photoacoustic sensor head for facilitating photoacoustic analysis of the UUT;
an input vent for receiving a stream of air into the chamber; and
an output vent through which a stream of air exits the chamber.

18. An acoustic isolation chamber comprising:
a housing defining a volume,
a first region of the volume is configured to receive one or more photoacoustic measurement cells,
a second region of the volume is configured to receive a unit under test (UUT);
wherein the first region is located in a first compartment and the second region is located in a second compartment.

19. An acoustic isolation chamber comprising:
a housing defining a volume,
a first region of the volume is configured to receive one or more photoacoustic measurement cells,
a second region of the volume is configured to receive a unit under test (UUT), and
a delivery mechanism for facilitating loading the UUT to the volume.

20. An acoustic isolation chamber comprising:
a housing defining a volume,
a first region of the volume is configured to receive one or more photoacoustic measurement cells,
a second region of the volume is configured to receive a unit under test (UUT); and
a moveable carrier member configured for mounting the UUT.
